(19) United States
(12) Patent Application Publication
(10) Pub. No.: US 2026/0078728 A1
(43) Pub. Date: Mar. 19, 2026

(54) FUEL SUPPLY DEVICE FOR INTERNAL COMBUSTION ENGINE

(71) Applicant: TOYOTA JIDOSHA KABUSHII KAISHA, Toyota-shi (JP)

(72) Inventors: Mina KAWAI TACHIBANA, Toyota-shi (JP); Akira KAMADA, Toyota-shi (JP); Tomihisa TSUCHIYA, Toyota-shi (JP)

(73) Assignee: TOYOTA JIDOSHA KABUSHII KAISHA, Toyota-shi (JP)

(21) Appl. No.: 19/207,756

(22) Filed: May 14, 2025

(30) Foreign Application Priority Data
Sep. 18, 2024 (JP) 2024-161071

(51) Int. Cl. F02M 37/00

(52) U.S. Cl. CPC F02M 37/0023

(57) ABSTRACT

The fuel supply device includes a fuel pipe of an internal combustion engine and a second cutoff valve that is an electromagnetic valve provided in the fuel pipe. The second cutoff valve includes a first valve body that is opened by energization to allow fuel to flow from an upstream side of the second cutoff valve to a downstream side of the second cutoff valve, and a second valve body that is opened when a pressure of the downstream side of the second cutoff valve becomes equal to or higher than a predetermined valve opening pressure by fuel flowing into the downstream side of the second cutoff valve by the opening of the first valve body. A downstream side pipe connected to a downstream side of the second cutoff valve includes a downstream valve that opens after a timing at which the second valve body opens.

### CROSS-REFERENCE TO RELATED APPLICATION

This application claims priority to Japanese Patent Application No. 2024-161071 filed on Sep. 18, 2024. The disclosure of the above-identified application, including the specification, drawings, and claims, is incorporated by reference herein in its entirety.

### BACKGROUND

### 1. Technical Field

The present disclosure relates to a fuel supply device for an internal combustion engine.

### 2. Description of Related Art

For example, a fuel supply device for an internal combustion engine described in Japanese Unexamined Patent Application Publication No. 2014-118842 (JP 2014-118842 A) includes a cutoff valve that is an electromagnetic valve in a fuel path connecting a fuel tank and a fuel injection valve. Further, at the time when the internal combustion engine is started, gas fuel having a needed pressure is supplied to the fuel injection valve by appropriately controlling a valve opening timing of the cutoff valve to improve startability.

### SUMMARY

As a structure of the electromagnetic valve, a structure including a first valve body and a second valve body can be considered. The first valve body is opened by energization to allow fuel to flow from an upstream side to a downstream side of an electromagnetic valve. The second valve body is opened in a case where a pressure on the downstream side of the electromagnetic valve becomes equal to or higher than a predetermined value by the fuel flowing to the downstream side of the electromagnetic valve by the opening of the first valve body. With the electromagnetic valve including the second valve body that is opened and closed by the pressure, a magnetic force needed to open the second valve body can be reduced. In a case where a magnetic force needed to open a valve is reduced, it is possible to, for example, downsize an electromagnetic valve or reduce the power consumption.

Here, the downstream side pressure of the electromagnetic valve while the second valve body is closed is a low pressure lower than the predetermined value. Therefore, in order to open the second valve body, the downstream side pressure that is being decreased needs to be increased to the predetermined value, and thus it takes time to increase the pressure. Therefore, there is a possibility that the time from the start of the energization to the opening of the second valve body is increased.

A fuel supply device for an internal combustion engine for solving the above problems includes a fuel path of the internal combustion engine, and an electromagnetic valve provided in the fuel path.

The electromagnetic valve includes a first valve body that is opened by energization to allow fuel to flow from an upstream side to a downstream side of the electromagnetic valve, and a second valve body that is opened in a case where a pressure on the downstream side of the electromagnetic valve becomes equal to or higher than a predetermined valve opening pressure by the fuel flowing to the downstream side of the electromagnetic valve due to the opening of the first valve body, and
the fuel path connected to the downstream side of the electromagnetic valve includes a valve that is opened after a timing at which the second valve body is opened.

The fuel supply device for an internal combustion engine can shorten a time from start of the energization until the opening of the second valve body of the electromagnetic valve.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an internal combustion engine, a fuel supply device, and a control device in an embodiment;

FIG. 2 is a cross-sectional view showing a structure of a second cutoff valve of the embodiment;

FIG. 3 is a timing chart showing the operation of the embodiment, in which a part (a) shows the transition of the downstream side pressure, a part (b) shows the transition of the opening and closing state of the first valve, a part (c) shows the transition of the opening and closing state of the second valve, and a part (d) shows the transition of the opening and closing state of the downstream valve;

FIG. 4 is a schematic diagram showing an internal combustion engine, a fuel supply device, and a control device in a modification example of the embodiment; and

FIG. 5 is a timing chart showing the opening and closing control of the downstream valve in the modification example. A part (a) shows the transition of the downstream side pressure, a part (b) shows the transition of the opening and closing state of the first valve, a part (c) shows the transition of the opening and closing state of the second valve, and a part (d) shows the transition of the opening and closing state of the downstream valve.

### DETAILED DESCRIPTION OF EMBODIMENTS

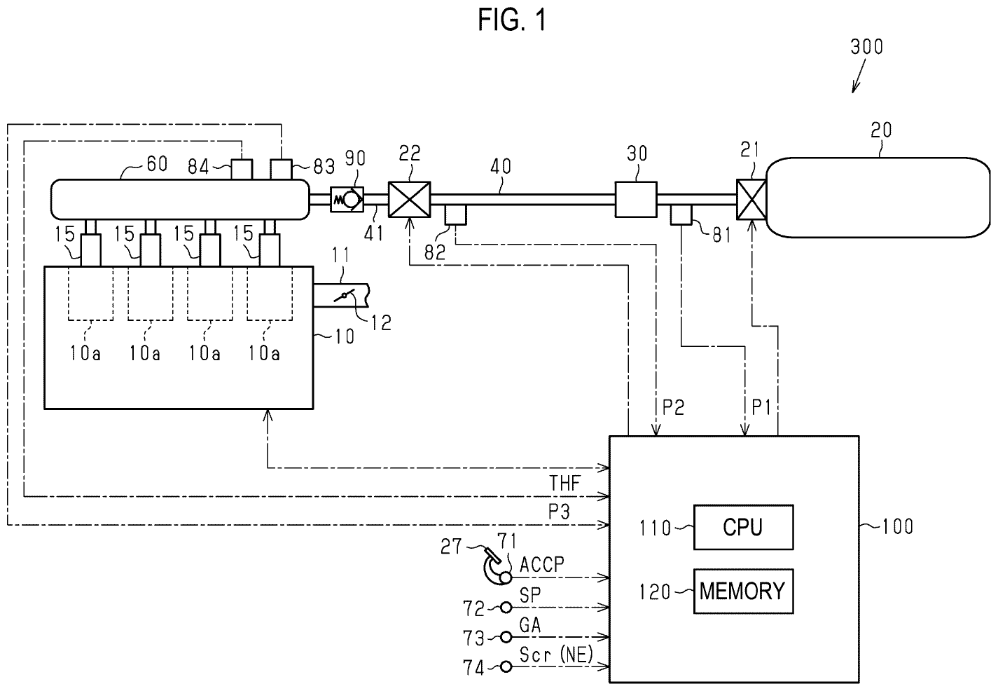

Hereinafter, an embodiment in which a fuel supply device for an internal combustion engine is embodied will be described with reference to FIGS. 1 to 3.

### Internal Combustion Engine, Fuel Supply Device, and Control Device

The internal combustion engine 10 shown in FIG. 1 is an internal combustion engine that is mounted on a vehicle and uses hydrogen gas as a gas fuel of a fluid.

A throttle valve 12 that adjusts an intake air amount is provided in an intake passage 11 of the internal combustion engine 10.

The fuel supply device 300 included in the internal combustion engine 10 includes a fuel injection valve 15, a tank 20, a fuel pipe 40, a first cutoff valve 21, a second cutoff valve 22, a pressure reducing valve 30, a delivery pipe 60, and a downstream valve 90.

The fuel injection valve 15 supplies fuel to a cylinder 10a of the internal combustion engine 10. The tank 20 stores hydrogen gas as a gaseous fuel in a state of being compressed at a high pressure. The fuel pipe 40 connects the tank 20 and the delivery pipe 60. The fuel injection valve 15 is connected to the delivery pipe 60. The fuel pipe 40 and the delivery pipe 60 are fuel paths connecting the tank 20 and the fuel injection valve 15. The hydrogen gas stored in the tank 20 is supplied to the fuel injection valve 15 through the fuel pipe 40 and the delivery pipe 60.

In the fuel pipe 40, the first cutoff valve 21, the pressure reducing valve 30, the second cutoff valve 22, and the downstream valve 90 are disposed in this order in the flow direction of the fuel. Hereinafter, an upstream side in a flow direction of the fuel is referred to as “upstream”, and a downstream side in the flow direction of the fuel is referred to as “downstream”.

The first cutoff valve 21 is an electromagnetic valve and is disposed near an outlet of the tank 20. When the first cutoff valve 21 is opened, fuel is supplied from the tank 20 to the fuel pipe 40. When the first cutoff valve 21 is closed, the fuel supply from the tank 20 to the fuel pipe 40 is stopped.

The pressure reducing valve 30 is a valve that reduces the fuel pressure which is the pressure of hydrogen gas stored in the tank 20 in a high pressure state to a predetermined pressure (for example, about 4 MPa) and supplies the reduced fuel pressure to the fuel injection valve 15.

The second cutoff valve 22 is an electromagnetic valve and is disposed near the delivery pipe 60 in the fuel pipe 40. When the second cutoff valve 22 is opened by the energization, the fuel is supplied to the delivery pipe 60. When the energization is stopped and the second cutoff valve 22 is closed, the fuel supply to the delivery pipe 60 is stopped.

The first cutoff valve 21 and the second cutoff valve 22 are closed during the stop of the operation of the internal combustion engine 10. On the other hand, the first cutoff valve 21 and the second cutoff valve 22 are basically opened during the operation of the internal combustion engine 10.

A first pressure sensor 81 provided in the fuel pipe 40 between the first cutoff valve 21 and the pressure reducing valve 30 detects a first pressure PI which is a fuel pressure in the fuel pipe 40 between the first cutoff valve 21 and the pressure reducing valve 30. The second pressure sensor 82 provided in the fuel pipe 40 between the pressure reducing valve 30 and the second cutoff valve 22 detects a second pressure P2 which is a fuel pressure in the fuel pipe 40 between the pressure reducing valve 30 and the second cutoff valve 22. The third pressure sensor 83 provided in the delivery pipe 60 detects a third pressure P3 that is a fuel pressure of the delivery pipe 60. The temperature sensor 84 provided in the delivery pipe 60 detects a fuel temperature THF which is a temperature of the fuel in the delivery pipe 60.

The second cutoff valve 22 and the delivery pipe 60 are connected to each other by a downstream side pipe 41. The downstream side pipe 41 is a part of the fuel pipe 40, and constitutes a part of the fuel path connected to the downstream side of the second cutoff valve 22.

The downstream valve 90 is provided in the downstream side pipe 41. The downstream valve 90 is a valve that is opened after the second valve 220 to be described later is opened. The downstream valve 90 is configured as a check valve that is opened when the pressure in the fuel path between the downstream valve 90 and the second cutoff valve 22 is equal to or higher than the second valve opening pressure Pb, and allows the fuel to flow from the upstream side of the downstream valve 90 to the downstream side. The second valve opening pressure Pb is set to a value within a range of the first valve opening pressure Pa described below or more and less than the pressure on the upstream side of the second cutoff valve 22. The pressure of the fuel on the upstream side of the second cutoff valve 22 is the pressure of the fuel flowing into the second cutoff valve 22, and is equal to the second pressure P2 which is the pressure of the fuel after being depressurized by the pressure reducing valve 30.

The control device 100 performs various controls, such as fuel injection of the internal combustion engine 10, by controlling various control targets, such as the throttle valve 12, the fuel injection valve 15, the first cutoff valve 21, and the second cutoff valve 22. The control device 100 includes a CPU 110 and a memory 120 including a ROM, a RAM, and the like, and the CPU 110 executes a program stored in the memory 120 to perform various controls.

The control device 100 refers to various values needed for controlling the internal combustion engine 10. For example, the control device 100 refers to the detection values of the first pressure sensor 81, the second pressure sensor 82, the third pressure sensor 83, and the temperature sensor 84. The control device 100 refers to a detection signal of an accelerator position sensor 71 that detects an accelerator operation amount ACCP which is an operation amount of an accelerator pedal 27 operated by a driver of a vehicle equipped with the internal combustion engine 10. The control device 100 refers to a detection signal of a speed sensor 72 that detects a vehicle speed SP of a vehicle equipped with the internal combustion engine 10. The control device 100 refers to a detection signal of an air flow meter 73 that detects the intake air amount GA of the internal combustion engine 10 or a detection signal Scr of a crank angle sensor 74 that detects a rotation angle of a crankshaft of the internal combustion engine 10.

### Structure of Second Cutoff Valve

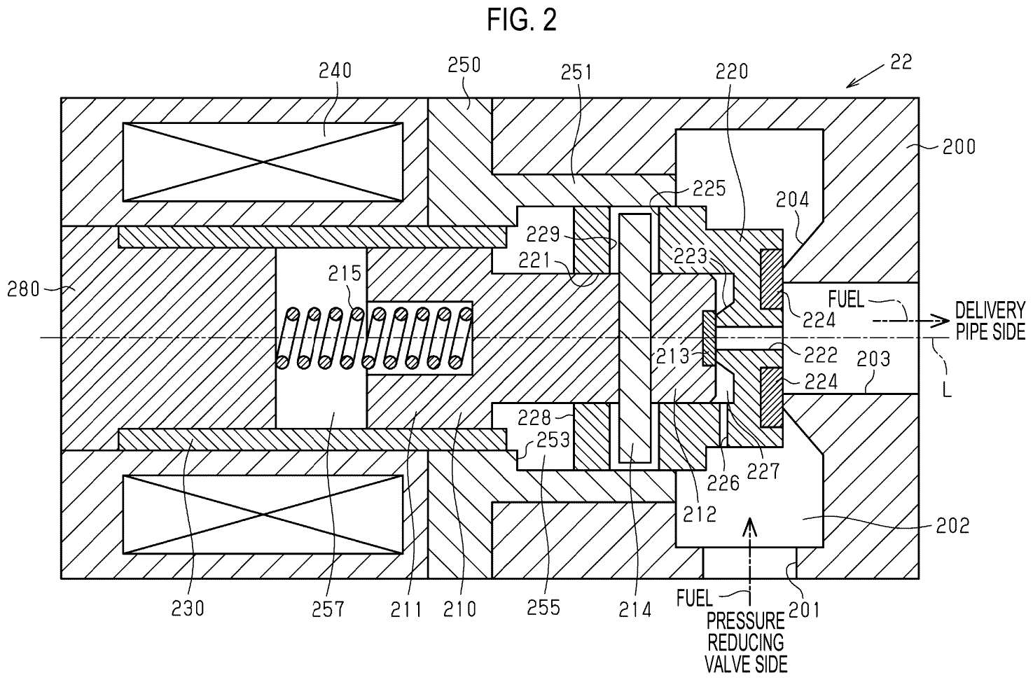

FIG. 2 shows the structure of the second cutoff valve 22. In the following, a direction along the center axis L of the plunger 211 included in the second cutoff valve 22 is referred to as an axial direction. In addition, a direction perpendicular to the axial direction is referred to as a radial direction.

The second cutoff valve 22 includes a housing 200, a stator 230, an electromagnetic coil 240, a first valve 210, a holder 250, a second valve 220, and the like. The housing 200 includes an inlet port 201 to which the fuel pipe 40 connected to the pressure reducing valve 30 is connected, and an outlet port 203 to which the fuel pipe 40 connected to the delivery pipe 60 is connected.

The inlet port 201 and the outlet port 203 communicate with each other through a first chamber 202 which is a space provided in the housing 200. The stator 230 is cylindrical and is provided in the housing 200.

The electromagnetic coil 240 is provided on the outer peripheral side of the stator 230. The electromagnetic coil 240 energizes to open the valve body.

The first valve 210 that is the first valve body includes a plunger 211 that moves in the axial direction inside the stator 230 and a first seal member 213 that opens and closes the first fuel path 222 by the movement of the plunger 211.

One end of the plunger 211 is a protrusion 212 that protrudes from the stator 230. The first seal member 213 is provided at the distal end of the protrusion 212. The protrusion 212 includes a pin 214 extending in the radial direction. Both ends of the pin 214 protrude from the outer peripheral surface of the protrusion 212.

The holder 250 has a tubular portion 251 coaxial with the center axis L. An inner peripheral surface of the tubular portion 251 faces and is separated from an outer peripheral surface of the protrusion 212.

The second valve 220 that is the second valve body is housed so as to be slidable on an inner peripheral surface of the tubular portion 251. The second valve 220 is provided with a hole 221 in which an outer peripheral surface of the protrusion 212 of the first valve 210 slides. The second valve 220 is provided with a long hole 225 that allows the pin 214 to be inserted and to move in the axial direction of the pin 214.

A first fuel path 222 extending in the axial direction is provided in the distal end of the second valve 220. The first fuel path 222 is connected to the outlet port 203 constituting the second fuel path. The outlet port 203 is a fuel path having a flow passage cross-sectional area larger than that of the first fuel path 222.

A second seal member 224 that opens and closes the outlet port 203 is provided at a distal end of the second valve 220. More specifically, the second seal member 224 opens and closes the second valve seat 204 provided at one end of the outlet port 203.

A first valve seat 223 that protrudes toward the protrusion 212 is provided on a distal end of the second valve 220 in which the first fuel path 222 is provided. The first fuel path 222 is opened by the opening and closing of the first valve seat 223 by the first seal member 213. The first fuel path 222 is a communication path that communicates a flow passage on an upstream side of the second valve body, the second valve 220, with a flow passage on a downstream side of the second valve 220. The flow path on the upstream side of the second valve 220 is the pressure chamber 227, a communication path 226 described below, the first chamber 202, and the inlet port 201. A flow path on a downstream side of the second valve 220 is the outlet port 203. The first valve 210 is a first valve body that opens before the second valve 220 opens and opens and closes the first fuel path 222.

In the hole 221, a space surrounded by the wall surface around the first valve seat 223 and the tip end surface of the protrusion 212 is a pressure chamber 227 in which a pressure that urges the second valve 220 in the valve closing direction is applied. The pressure chamber 227 is connected to the first chamber 202 through the communication path 226.

A second chamber 255 that is a space for securing a stroke amount of the second valve 220 in the axial direction is provided on an inner peripheral surface side of the tubular portion 251 of the holder 250.

An end surface 228 on a side opposite to the side where the second seal member 224 is disposed in the second valve 220 and a restricted portion 253 that is configured by a surface facing the end surface 228 in the holder 250 come into contact with each other when the second valve 220 is in a fully open state. By maintaining the state in which the end surface 228 and the restricted portion 253 are in contact with each other, the position of the valve body when the second valve 220 is in the fully open state is stabilized.

Inside the stator 230, an end cap 280 that closes an end portion on the side opposite to the side where the plunger 211 is inserted is provided. A third chamber 257 that is a space is provided between the end cap 280 and the plunger 211. Further, a spring 215 that biases the plunger 211 in a direction of separating from the end cap 280 is provided between the end cap 280 and the plunger 211.

### Opening Operation of Second Cutoff Valve

At the time when the energization to the electromagnetic coil 240 is started at the time of the start of the engine, the plunger 211 is pulled into the stator 230, and the first valve 210 moves in a direction in which the first seal member 213 is separated from the first valve seat 223. By the movement of the first valve 210, the opening operation of the first valve 210 is performed. When the first seal member 213 is separated from the first valve seat 223, the fuel flowing in from the inlet port 201 flows into the outlet port 203 through the first chamber 202, the communication path 226, the pressure chamber 227, and the first fuel path 222. As described above, the second cutoff valve 22 has the first valve 210 that is opened by energization to allow the fuel to flow from the upstream side to the downstream side of the second cutoff valve 22.

Then, the first valve 210 moves in a direction in which the first seal member 213 is separated from the first valve seat 223. As a result, the pin 214 of the first valve 210 hits the wall surface 229 that is positioned in the opening direction of the first valve 210 in the axial direction of the long hole 225 of the second valve 220. Therefore, the second valve 220 is added with a valve opening force Fop that acts in the same direction as the movement direction of the first valve 210. The valve opening force Fop is a suction force generated by the magnetic force of the electromagnetic coil 240, and acts in a direction in which the second valve 220 is opened.

When the first valve 210 is opened, the pressure chamber 227 and the outlet port 203 communicate with each other, so that fuel flows from the upstream side to the downstream side of the second cutoff valve 22. When the fuel flows from the upstream side to the downstream side of the second cutoff valve 22, the fuel pressure on the outlet port 203 side which is the pressure downstream of the second cutoff valve 22 increases. Therefore, the pressure difference between the pressure chamber 227 and the outlet port 203 is reduced. Therefore, the resistance Fcl which is a force against the valve opening of the second valve 220 is reduced. The resistance Fcl includes a force acting in a closing direction of the second valve 220 and a sliding resistance of the second valve 220 and the holder 250. The force acting in the closing direction of the second valve 220 includes a differential pressure load or the biasing force of the spring 215 generated by a pressure difference between the pressure chamber 227 and the outlet port 203.

When the differential pressure load is reduced by the opening of the first valve 210, the second valve 220 moves in a direction in which the second seal member 224 is separated from the second valve seat 204 when the valve opening force Fop is greater than the resistance Fcl. The second valve 220 is moved to perform an opening operation of the second valve 220. In this way, the pressure on the downstream side of the second cutoff valve 22 when the second valve 220 is opened is the first valve opening pressure Pa. The first valve opening pressure Pa is, for example, a value in which the suction force of the electromagnetic coil 240 or the pressure receiving area of the second valve 220 is involved. When the second seal member 224 is separated from the second valve seat 204, the fuel flowing in from the inlet port 201 mainly flows into the outlet port 203 through the first chamber 202.

When the second valve 220 is in the fully open state, the second valve 220 is stopped from moving in the axial direction by the contact between the end surface 228 and the restricted portion 253. The fuel flowing into the outlet port 203 is supplied to the fuel injection valve 15 via the downstream side pipe 41 and the delivery pipe 60.

In the present embodiment, the second valve opening pressure Pb is set to a pressure value lower than a second pressure P2 which is a pressure on the upstream side of the second cutoff valve 22. In addition, the first valve opening pressure Pa is set to a pressure value lower than the second valve opening pressure Pb. That is, the relationship between the first valve opening pressure Pa, the second valve opening pressure Pb, and the second pressure P2 is “the first valve opening pressure Pa<the second valve opening pressure Pb<the second pressure P2”.

The second cutoff valve 22 has the second valve 220 that is opened when the pressure on the downstream side of the second cutoff valve 22 becomes equal to or higher than a predetermined first valve opening pressure Pa due to the fuel flowing into the downstream side of the second cutoff valve 22 by the opening of the first valve 210. In the second cutoff valve 22 having the second valve 220, when the fuel pressure in the outlet port 203 increases and becomes equal to or higher than the first valve opening pressure Pa, the pressure difference between the pressure chamber 227 and the outlet port 203 is reduced. That is, the pressure difference between the upstream side and the downstream side of the second valve 220 is reduced, and the second valve 220 is opened. Therefore, the magnetic force needed for valve opening can be reduced as compared with a case where the magnetic force of the electromagnetic coil is directly used to open the second valve 220. Therefore, for example, the electromagnetic coil 240 can be reduced in size.

### Closing Operation of Second Cutoff Valve

When the energization to the electromagnetic coil 240 is stopped, the first valve 210 moves in a direction in which the first seal member 213 hits the first valve seat 223 due to the urging force of the spring 215 or the like. As a result, the closing operation of the first valve 210 is performed.

When the first seal member 213 comes into contact with the first valve seat 223, the biasing force of the spring 215 acts on the second valve 220. Therefore, the second valve 220 moves in a direction in which the second seal member 224 comes into contact with the second valve seat 204. As a result, the closing operation of the second valve 220 is performed.

### Operation of Present Embodiment

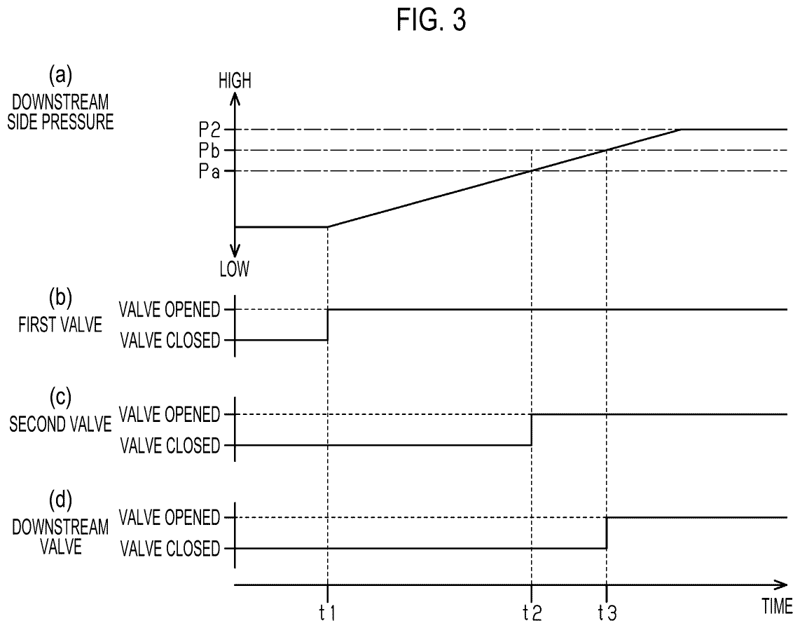

FIG. 3 shows the action of the present embodiment. The part (a) of FIG. 3 shows a transition of the downstream side pressure, the part (b) of FIG. 3 shows a transition of the opening and closing states of the first valve 210, the part (c) of FIG. 3 shows a transition of the opening and closing states of the second valve 220, and the part (d) of FIG. 3 shows a transition of the opening and closing states of the downstream valve 90. The downstream side pressure shown in the partial view (a) of FIG. 3 is a fuel pressure in a fuel path between the second cutoff valve 22 and the downstream valve 90.

When the engine start is started at time t1, the energization to the electromagnetic coil 240 is started, so that the first valve 210 that was closed is opened. With the opening of the first valve 210, the fuel inflow from the pressure chamber 227 to the outlet port 203 is started, and thus the downstream side pressure increases toward the second pressure P2.

At time t2, when the downstream side pressure reaches the first valve opening pressure Pa, the second valve 220 is opened.

At time t3, when the downstream side pressure reaches the second valve opening pressure Pb, the downstream valve 90 that is closed is opened. In a case where the downstream valve 90 is opened after the second valve 220 is opened in this way, the fuel supply to the fuel injection valve 15 through the downstream side pipe 41 and the delivery pipe 60 is started.

### Effect of Embodiment

(1) When the first valve 210 is energized to be opened, the pressure on the downstream side of the second cutoff valve 22 increases due to the fuel flowing into the downstream side of the second cutoff valve 22. Here, the downstream valve 90 provided in the downstream side pipe 41 connected to the downstream side of the second cutoff valve 22 is opened after the second valve 220 of the second cutoff valve 22 is opened. That is, the downstream valve 90 is in a valve-closed state until at least the second valve 220 of the second cutoff valve 22 is opened.

When the downstream valve 90 is closed, the volume of the fuel path from the second cutoff valve 22 to the downstream side cutoff end of the second cutoff valve 22 is smaller than the volume of the fuel path when the downstream valve 90 is open. As the volume of the fuel path is smaller, the increase in the downstream side pressure of the second cutoff valve 22 after the first valve 210 is opened is faster, and thus the time until the pressure on the downstream side of the second cutoff valve 22 becomes equal to or higher than the first valve opening pressure Pa is shorter. Therefore, it is possible to shorten a time from when the energization of the second cutoff valve 22 is started until the second valve 220 is opened.

(2) In a case where the valve opening delay of the second valve 220 occurs in the engine start, the fuel flow rate needed for the engine start cannot be sufficiently secured, and thus, for example, the engine start time may be long. In this regard, in the present embodiment, the time from the start of the energization of the second cutoff valve 22 to the opening of the second valve 220 is shortened, so that the second valve 220 is quickly opened at the time of the engine start. Therefore, it is possible to suppress an increase in the engine start time.

(3) A downstream valve 90 that is a check valve is provided in the downstream side pipe 41. The downstream valve 90 is opened when the pressure in the fuel path between the downstream valve 90 and the second cutoff valve 22 is equal to or higher than the second valve opening pressure Pb, and allows the fuel to flow from the upstream side of the downstream valve 90 to the downstream side. The second valve opening pressure Pb is set to a value within a range of the first valve opening pressure Pa or more at which the second valve 220 is opened and less than the pressure on the upstream side of the second cutoff valve 22.

As described above, the second valve opening pressure Pb which is the pressure at which the downstream valve 90 opens is a value equal to or higher than the first valve opening pressure Pa which is the pressure at which the second valve 220 opens. Therefore, the downstream valve 90 is opened after the second valve 220 is opened. Therefore, a valve that is opened after the timing at which the second valve 220 is opened can be provided in the fuel path.

In addition, the second valve opening pressure Pb is a value less than the pressure on the upstream side of the second cutoff valve 22. Therefore, after both the second valve 220 and the downstream valve 90 are opened, the downstream valve 90 can be maintained in the valve open state by the pressure of the fluid on the upstream side of the second cutoff valve 22.

### Modification Example

The embodiment can be modified and implemented as follows. The embodiment and the following modification examples can be carried out in combination within a technically consistent range.

By setting the second valve opening pressure Pb to be the same as the first valve opening pressure Pa as described above, the downstream valve 90 may be opened immediately after the second valve 220 is opened.

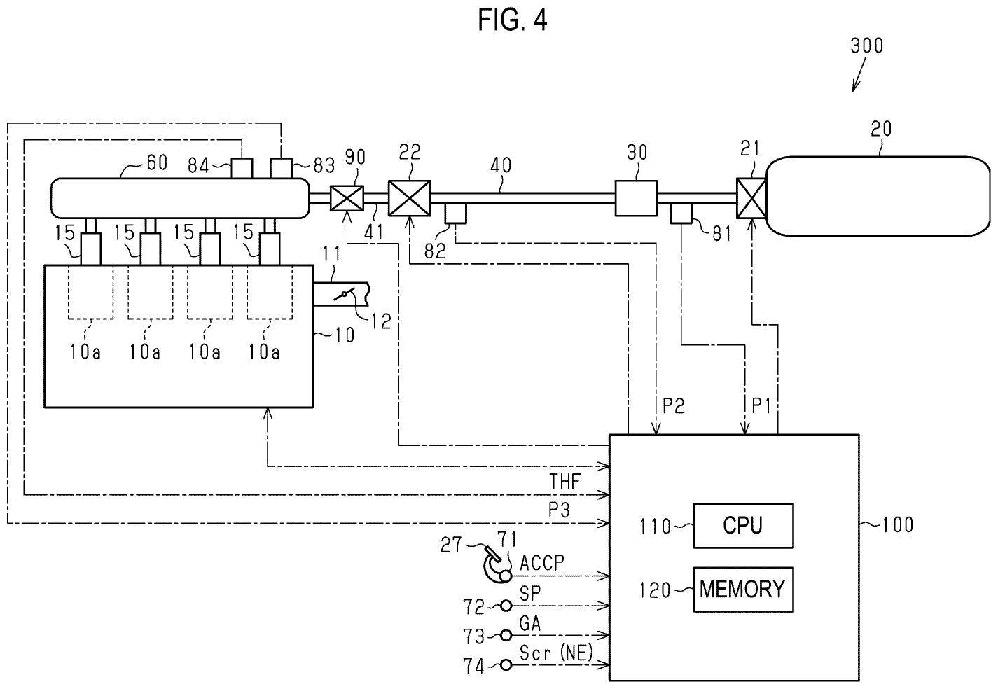

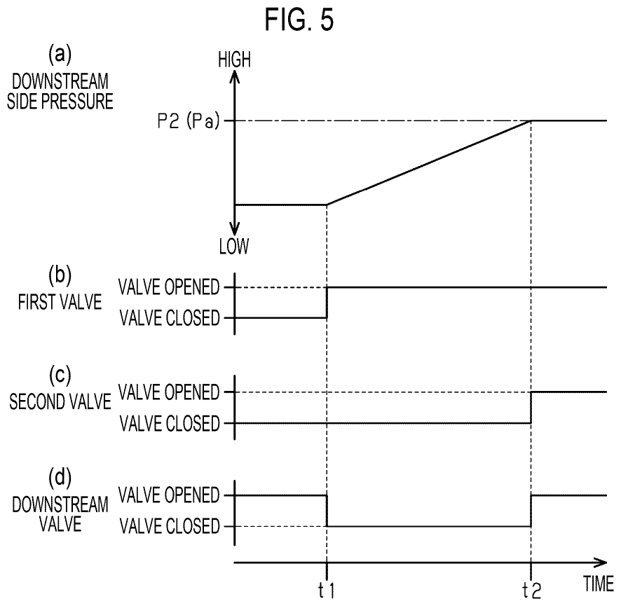

As shown in FIGS. 4 and 5, the downstream valve 90 may be configured by an electromagnetic valve that is driven to open when the second valve 220 is opened. In this case, the control device 100 may perform the drive control of the downstream valve 90, for example, as follows.

FIG. 5 shows an example of the opening and closing control of the downstream valve 90 in the modification example. The part (a) of FIG. 5 shows a transition of the downstream side pressure, the part (b) of FIG. 5 shows a transition of the opening and closing states of the first valve 210, the part (c) of FIG. 5 shows a transition of the opening and closing states of the second valve 220, and the part (d) of FIG. 5 shows a transition of the opening and closing states of the downstream valve 90. The downstream side pressure shown in the part (a) of FIG. 5 is the same as the downstream side fuel pressure shown in FIG. 3, and is a fuel pressure in a fuel path between the second cutoff valve 22 and the downstream valve 90. In the modification example, the second pressure P2 which is the pressure of the fuel after being depressurized by the pressure reducing valve 30 and is the pressure on the upstream side of the second cutoff valve 22 is set to the first valve opening pressure Pa, but the first valve opening pressure Pa may be set to a pressure value lower than the second pressure P2.

The downstream valve 90 is, for example, a normally open electromagnetic valve, and is closed when energization is performed.

When the engine start is started at time t1, the first valve 210 that has been closed is opened by starting the energization to the second cutoff valve 22. With the opening of the first valve 210, the fuel inflow from the pressure chamber 227 to the outlet port 203 is started, and thus the downstream side pressure increases toward the second pressure P2.

In addition, at time t1, the control device 100 starts the energization to the downstream valve 90. As a result, the downstream valve 90 that was in the valve open state before time t1 is in the valve closed state.

At time t2, when the downstream side pressure reaches the first valve opening pressure Pa, the second valve 220 is opened. When the opening of the second valve 220 is detected, the control device 100 stops the energization to the downstream valve 90. As a result, the downstream valve 90 that is in the closed valve state after time t1 is in the open valve state. When the downstream valve 90 is opened, the fuel supply to the fuel injection valve 15 through the downstream side pipe 41 and the delivery pipe 60 is started.

The detection of the valve opening of the second valve 220 can be appropriately performed. For example, when the second valve 220 that is in a closed state is in an open state, the actual electric current flowing through the electromagnetic coil 240 temporarily decreases. Therefore, in a case where such a temporary decrease in the actual current is detected, the determination can be made that the second valve 220 is opened. In addition, when the second valve 220 is in the valve open state, the downstream side pressure which is the fuel pressure in the fuel path between the second cutoff valve 22 and the downstream valve 90 is maintained in a state of being equal to the second pressure P2. Therefore, the second valve 220 can be determined to be opened in a case where the downstream side pressure is detected and the behavior of the downstream side pressure is detected.

Although the fuel of the internal combustion engine 10 is hydrogen gas as the gaseous fuel, other gaseous fuels, such as compressed natural gas, may be used. Although the fuel of the internal combustion engine 10 is the gaseous fuel, the fuel may be a liquid fuel.

What is claimed is:

1. A fuel supply device for an internal combustion engine, the fuel supply device comprising:
a fuel path of the internal combustion engine; and
an electromagnetic valve provided in the fuel path, wherein:
the electromagnetic valve includes a first valve body that is opened by energization to allow fuel to flow from an upstream side to a downstream side of the electromagnetic valve, and a second valve body that is opened in a case where a pressure on the downstream side of the electromagnetic valve becomes equal to or higher than a predetermined valve opening pressure by the fuel flowing to the downstream side of the electromagnetic valve due to the opening of the first valve body; and
the fuel path connected to the downstream side of the electromagnetic valve includes a valve that is opened after a timing at which the second valve body is opened.

2. The fuel supply device according to claim 1, wherein:
the valve opening pressure is a first valve opening pressure;
the valve is a check valve that is opened to allow fuel to flow from an upstream side to a downstream side of the valve in a case where a pressure inside the fuel path between the valve and the electromagnetic valve becomes equal to or higher than a second valve opening pressure; and
the second valve opening pressure is set to a value within a range of equal to or higher than the first valve opening pressure and lower than a pressure on the upstream side of the electromagnetic valve.

3. The fuel supply device according to claim 1, wherein the valve is an electromagnetic valve that is driven to be opened in a case where the second valve body is opened.
